(19) United States
(12) Patent Application Publication
(10) Pub. No.: US 2005/0118513 A1
(43) Pub. Date: Jun. 2, 2005

(54) Electrolyte and battery using it

(75) Inventor: Shinsaku Ugawa, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/984,606

(22) Filed: Nov. 9, 2004

(30) Foreign Application Priority Data
Nov. 28, 2003 (JP) P2003-399914

(51) Int. Cl. H01M 10/40

(52) U.S. Cl. 429/339; 429/340

(57) ABSTRACT

The invention provides a battery coverable of inhibiting self-discharge even when the battery is left under the circumstances of high temperatures and an electrolyte used for the battery. An electrode winding body in which a cathode and an anode are layered and wound with a separator in between is provided inside a battery can. An electrolytic solution is impregnated in the separator. The electrolytic solution contains at least one of compounds having structures shown below and an ionic liquid shown below.

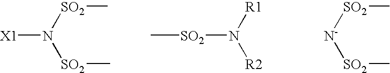

### BACKGROUND OF THE INVENTION

1. Field of the Invention

The present invention relates to an electrolyte containing a compound including a specific structure, and a battery using it.

2. Description of the Related Art

In recent years, many portable electronic devices such as a laptop portable computer, a mobile phone, and a combination camera (video tape recorder) have been introduced. Downsizing and weight saving of these devices have been made. Along with these situations, as a power source for these portable electronic devices, a light weight secondary battery coverable of providing a high energy density has been developed. As a secondary battery coverable of providing a high energy density, for example, a lithium ion secondary battery using a material capable of inserting and extracting lithium (Li) such as a carbon material as an anode active material, or a lithium metal secondary battery using metallic lithium as an anode active material is known.

In the lithium ion secondary battery or the lithium secondary battery, conventionally, in order to improve battery characteristics such as cycle characteristics, adding various additives to an electrolyte has been considered (for example, refer to Japanese Unexamined Patent Application Publication Nos. H07-37612, H08-167426, and H09-92329).

However, along with grow in usage of the mobile electronic devices, recently, there is a problem that battery characteristics are lowered when such a mobile electronic device is under the circumstances of high temperatures, for example, in transportation and utilization thereof. It is thinkable that the reason thereof is as follows. When a temperature is raised, part of a lithium salt is decomposed, free acid is generated, and thereby, self-discharge is caused. Therefore, development of an electrolyte capable of effectively inhibiting action of the generated free acid and inhibiting the self-discharge under the circumstances of high temperatures has been aspired.

### SUMMARY OF THE INVENTION

In view of the foregoing problems, it is an object of the invention to provide a battery coverable of inhibiting self-discharge even when the battery is left under the circumstances of high temperatures and an electrolyte used for the battery.

An electrolyte according to the invention is an electrolyte, containing at least one from the group consisting of a compound having a structure shown in Chemical formula 1, a compound having a structure shown in Chemical formula 2, and an ionic liquid having a structure shown in Chemical formula 3. 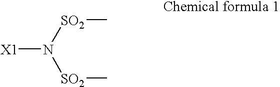
(In the formula, X1 represents any of a hydrogen group, a halogen group, and a group containing carbon.) 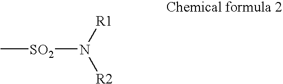
(In the formula, R1 and R2 represent a group containing carbon, and R1 and R2 are bonded by nitrogen and carbon.)

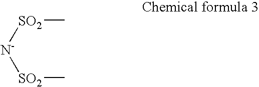

A battery according to the invention is a battery, comprising: a cathode; an anode; and an electrolyte, wherein the electrolyte contains at least one from the group consisting of a compound having a structure shown in Chemical formula 1, a compound having a structure shown in Chemical formula 2, and an ionic liquid having a structure shown in Chemical formula 3.

According to the electrolyte of the invention, since at least one from the group consisting of the compound having the structure shown in Chemical formula 1, the compound having the structure shown in Chemical formula 2, and the ionic liquid having the structure shown in Chemical formula 3 is contained, free acid can be effectively captured by unpaired electrons of nitrogen contained in the compound. Therefore, according to the battery of the invention, even if free acid causing self-discharge is generated under the conditions of high temperature, the free acid can be captured by the electrolyte. Consequently, a self-discharge ratio at high temperatures can be lowered, and lowering of a capacity due to self-discharge can be inhibited even when the battery is left under the circumstances of high temperatures.

Other and further objects, features and advantages of the invention will appear more fully from the following description.

### BRIEF DESCRIPTION OF THE DRAWINGS

FIG. 1 is a cross section showing a construction of a secondary battery according to an embodiment of the invention;

FIG. 2 is a cross section showing a construction taken along line II-II of an electrode winding body shown in FIG. 1; and

FIG. 3 is a cross section showing another construction taken along the line II-II of the electrode winding body shown in FIG. 1.

### DETAILED DESCRIPTION OF THE PREFERRED EMBODIMENT

An embodiment of the invention will be described in detail hereinafter with reference to the drawings.

An electrolyte according to the embodiment of the invention contains, for example, a liquid so-called electrolytic solution containing a solvent and an electrolyte salt dissolved in the solvent. As a solvent, for example, nonaqueous solvents such as ethylene carbonate, dimethyl carbonate, diethyl carbonate, ethyl methyl carbonate, vinylethylene carbonate, vinylene carbonate, 1,2-dimethoxy ethane, 1,2-diethoxy ethane, γ-butyrolactone, tetrahydrofuran, 2-methyltetrahydrofuran, 1,3-dioxolane, 4-methyl-1,3-dioxolane, diethyl ether, sulfolane (tetrahydrothiophene-1,1-dioxide), methyl sulfolane, acetonitrile, propionitrile, anisole, ester acetate, ester butyrate, and ester propionate can be cited. One of the above can be singly used, or a mixture of two or more of the above can be used as a solvent.

As an electrolyte salt, for example, lithium salts such as LiClO₄, LiAsF₆, LiPF₆, LiBF₄, LiB(C₆H₅)₄, LiCH₃SO₃, LiCF₃SO₃, LiCl, and LiBr can be cited. One of the above can be singly used, or a mixture of two or more of the above can be used as an electrolyte salt.

A concentration of the electrolyte salt is, for example, preferably in the range from 0.3 mol/l to 3.0 mol/l to the solvent. When the concentration of the electrolyte salt is in this range, high ion conductivity can be obtained.

Further, this electrolyte contains, as an additive, at least one from the group consisting of a compound having a structure shown in Chemical formula 1, a compound having a structure shown in Chemical formula 2, and an ionic liquid having a structure shown in Chemical formula 3. These compounds have unpaired electrons in nitrogen. Therefore, free acid generated due to decomposition of the electrolyte salt or the like can be effectively captured, and self-discharge due to the free acid can be inhibited.

As a compound having the structure shown in Chemical formula 1, for example, a compound shown in Chemical formula 4 can be cited.

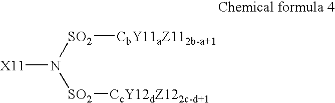

(In the formula, X11 represents any of a hydrogen group, a halogen group, an alkyl group, a phenyl group, a pyridine ring, and a derivative thereof. Y11 and Y12 represent a hydrogen group or a halogen group. Z11 and Z12 represent any of a hydrogen group, a halogen group, an alkyl group, a phenyl group, a pyridine ring, and a derivative thereof. Y11 and Y12 (or Z11 and Z12) can be identical or different. a, b, c and d represent an integer number of 1 or upper. 2b−a+1 and 2c−d+1 represent an integer number of 0 or upper. These integer numbers can be identical or different.)

Concrete examples of the compound shown in Chemical formula 4 include compounds shown in Chemical formulas 5 to 9.

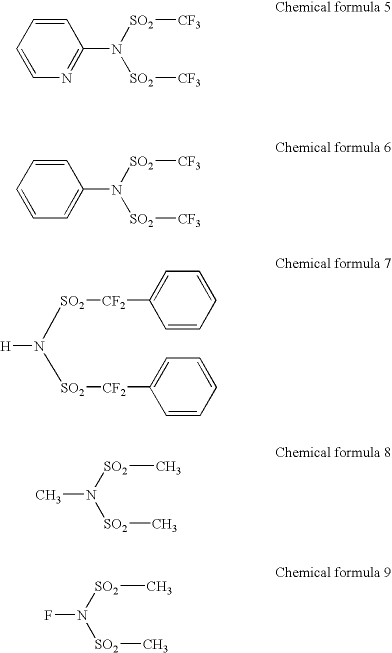

Examples of a compound having the structure shown in Chemical formula 2 include a compound shown in Chemical formula 10.

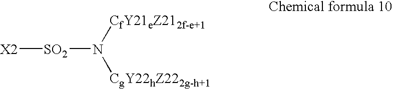

(In the formula, X2 represents any of a hydrogen group, a halogen group, an alkyl group, a phenyl group, a pyridine ring, and a derivative thereof. Y21 and Y22 represent a hydrogen group or a halogen group. Z21 and Z22 represent any of a hydrogen group, a halogen group, an alkyl group, a phenyl group, a pyridine ring, and a derivative thereof. Y21 and Y22 (or Z21 and Z22) can be identical or different. e, f, g and h represent an integer number of 1 or upper. 2f−e+1 and 2g−h+1 represent an integer number of 0 or upper. These integer numbers can be identical or different.)

Concrete examples of the compound shown in Chemical formula 10 include compounds shown in Chemical formulas 11 to 13.

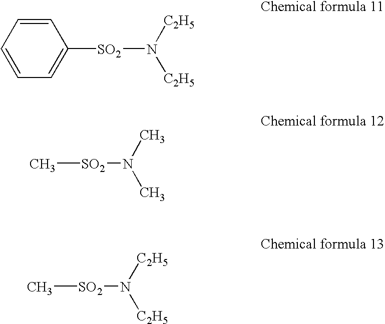

As an ionic liquid having the structure shown in Chemical formula 3, for example, a compound shown in Chemical formula 14 can be cited.

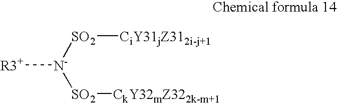

(In the formula, R3 represents fourth class amine. Y31 and Y32 represent a hydrogen group or a halogen group. Z31 and Z32 represent any of a hydrogen group, a halogen group, an alkyl group, a phenyl group, a pyridine ring, and a derivative thereof. Y31 and Y32 (or Z31 and Z32) can be identical or different. i, j, k and m represent an integer number of 1 or upper. 2i−j+1 and 2k−m+1 represent an integer number of 0 or upper. These integer numbers can be identical or different.)

Concrete examples of the ionic liquid shown in Chemical formula 14 include a compound shown in Chemical formula 15.

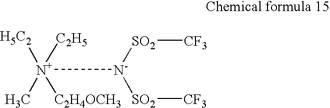

Concentrations of the compound having the structure shown in Chemical formula 1, the compound having the structure shown in Chemical formula 2, and the ionic liquid having the structure shown in Chemical formula 3 are not particularly limited. However, an excessively high concentration is not preferable since such a high concentration adversely affects other characteristics such as cycle characteristics. For example, the concentrations of these compounds are preferably 1 mol/l or less in total to a solvent.

This electrolyte can be a so-called electrolytic solution containing the foregoing solvent, electrolyte salt, and additive. Further, this electrolyte can be gelated by containing a high molecular weight compound which holds the foregoing solvent, electrolyte salt, and additive. Any high molecular weight compound can be used as long as a high molecular weight compound absorbs and gelates the electrolytic solution. For example, a fluoro high molecular weight compound such as polyvinylidene fluoride and a copolymer of vinylidene fluoride and hexafluoro propylene; an ether high molecular weight compound such as polyethylene oxide and a cross-linked polymer containing polyethylene oxide; and polyacrylonitrile can be cited. In particular, in view of redox stability, the fluoro high molecular weight compound is desirable.

Further, the electrolytic solution can be held in an inorganic solid conductor consisting of ion-conducting glass, an ionic crystal or the like. Otherwise, the electrolytic solution can be held in a mixture of the inorganic solid conductor and the foregoing high molecular weight compound. As an inorganic solid conductor, for example, a substance containing lithium nitride, lithium iodide or the like can be cited.

This electrolyte is, for example, used for a secondary battery as follows.

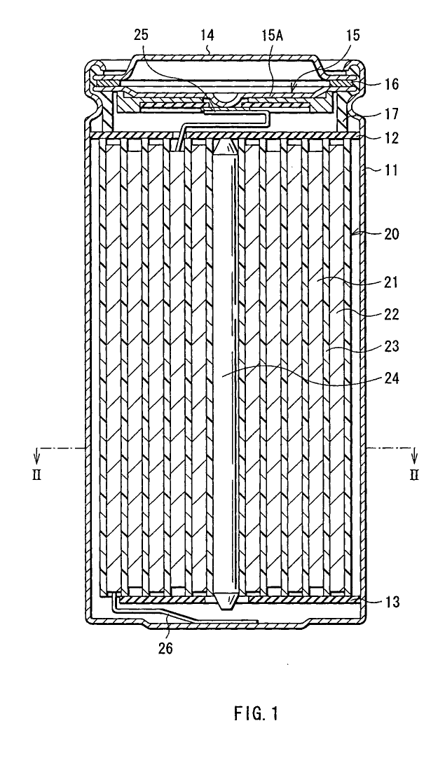

FIG. 1 shows a cross sectional structure of a secondary battery using this electrolyte. This secondary battery is a so-called cylinder-type battery, and has an electrode winding body 20 inside a battery can 11 in the shape of an approximately hollow cylinder. The battery can 11 is made of, for example, iron (Fe) plated by nickel (Ni). One end of the battery can 11 is closed, and the other end of the battery can 11 is opened. Inside the battery can 11, a pair of insulating plates 12 and 13 are respectively arranged so that the electrode winding body 20 is sandwiched between the insulating plates 12 and 13, and the insulating plates 12 and 13 are located perpendicular to the winding periphery face.

At the open end of the battery can 11, a battery cover 14, and a safety valve mechanism 15 and a PTC (Positive Temperature Coefficient) device 16 provided inside the battery cover 14 are installed by caulking through a gasket 17. Inside of the battery can 11 is closed. The battery cover 14 is, for example, made of a material similar to that of the battery can 11. The safety valve mechanism 15 is electrically connected to the battery cover 14 through the PTC device 16. When an inner pressure of the battery becomes a certain level or more by inner short circuit or exterior heating, a disk plate 15A flips to cut the electrical connection between the battery cover 14 and the electrode winding body 20. When a temperature rises, the PTC device 16 limits a current by increasing its resistance value to prevent abnormal heat generation by a large current. The gasket 17 is made of, for example, an insulating material and a surface thereof is coated with asphalt.

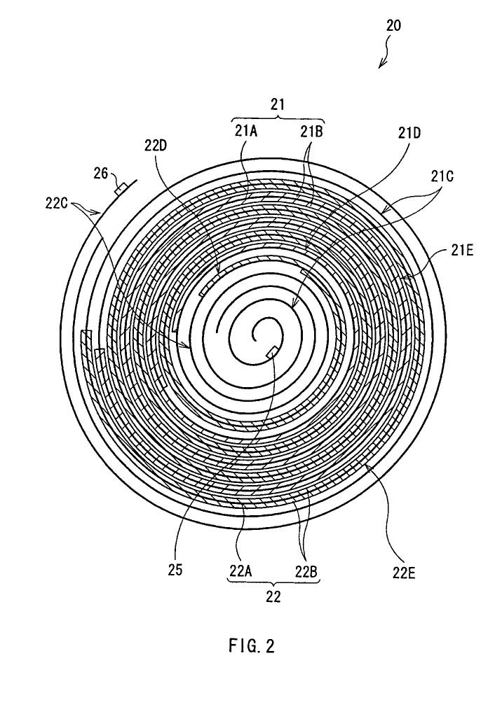

FIG. 2 is a view showing a cross sectional construction taken along line II-II of the electrode winding body 20 shown in FIG. 1. The electrode winding body 20 is formed by layering and winding a strip-shaped cathode 21 and a strip-shaped anode 22 with a separator 23 in between. A center pin 24 is inserted in the center of the electrode winding body 20. In FIG. 2, the separator 23 is omitted. A cathode lead 25 made of aluminum (Al) or the like is connected to the cathode 21 of the electrode winding body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

The cathode 21 has, for example, a current collector 21A having a pair of facing faces and active material layer 21B provided on both sides or on a single side of the current collector 21A. The current collector 21A is made of, for example, aluminum, nickel, or stainless.

The active material layer 21B contains, for example, one or more cathode materials capable of inserting and extracting lithium as a cathode active material. The active material layer 21B can also contain a conductive agent such as a carbon material and a binder such as polyvinylidene fluoride according to need. As a cathode material capable of inserting and extracting lithium, for example, lithium complex oxide containing lithium and a transition metal, or a lithium phosphoric acid compound is preferable. Since lithium complex oxide and the lithium phosphoric acid compound can generate a high voltage and have a high density, a high capacity can be obtained.

Lithium complex oxide containing at least one from the group consisting of cobalt (Co), nickel, manganese (Mn), iron, vanadium (V), titanium (Ti), chromium (Cr), and copper (Cu) as a transition metal is preferable. Lithium complex oxide containing at least one from the group consisting of cobalt, nickel, manganese, iron, vanadium, and titanium is more preferable. Of the foregoing, as lithium complex oxide containing manganese, for example, a spinel type compound expressed by a chemical formula of LiₓMn_{2-y}M1_{y}O₄ can be cited. In the formula, M1 represents at least one from the group consisting of iron, cobalt, nickel, copper, zinc (Zn), aluminum, tin (Sn), chromium, vanadium, titanium, magnesium (Mg), calcium (Ca), strontium (Sr), boron (B), gallium (Ga), indium (In), silicon (Si), and germanium (Ge). Values of x and y are 0.9≦x and 0.01≦y≦0.5, respectively. An example of lithium complex oxide containing nickel is expressed by a chemical formula of LiNi_{1-z}M2_{z}O₂. In the formula, M2 represents at least one from the group consisting of iron, cobalt, manganese, copper, zinc, aluminum, tin, chromium, vanadium, titanium, magnesium, calcium, strontium, boron, gallium, indium, silicon, and germanium. A value of z is 0.01≦z≦0.5. Concrete examples of such lithium complex oxide include LiCoO₂, LiNiO₂, LiMn₂O₄, LiNi_{0.5}Co_{0.5}O₂, and LiNi_{0.5}Co_{0.3}Mn_{0.2}O₂.

In addition, as a lithium phosphoric acid compound, for example, LiFePO₄ or LiFe_{0.5}Mn_{0.5}PO₄ can be cited.

As the cathode 21 does, the anode 22 has, for example, a current collector 22A having a pair of facing faces and active material layer 22B provided on both sides or on a single side of the current collector 22A. The current collector 22A is made of, for example, copper, nickel, or stainless.

The active material layer 22B contains, for example, one or more anode materials capable of inserting and extracting lithium as an anode active material. The active material layer 22B can contain a binder similar to in the cathode 21 according to need. Examples of the anode material capable of inserting and extracting lithium include carbon materials, metal oxides, and high molecular weight materials. Examples of the carbon materials include artificial graphite, natural graphite, graphitizable carbon, cokes, graphite, glassy carbons, organic high molecular weight compound sintered body, carbon fiber, activated carbon, carbon blacks, and non-graphitizable carbon. Examples of the cokes include pitch coke, needle coke, and petroleum coke. The organic high molecular weight compound sintered body is obtained by firing at appropriate temperatures and carbonizing a high molecular weight material such as phenyls and furans. Further, examples of the metal oxides include iron oxide, ruthenium oxide, molybdenum oxide, tin oxide, and tungsten oxide. Examples of the high molecular weight materials include polyacetylene and polypyrrole.

Examples of the anode material capable of inserting and extracting lithium include simple substances, alloys, and compounds of metal elements or metalloid elements capable of forming an alloy with lithium. Examples of the alloys include alloys consisting of two or more metal elements and, in addition, alloys consisting of one or more metal elements and one or more metalloid elements. Examples of structures thereof include a solid solution structure, a eutectic (eutectic mixture) structure, an intermetallic compound structure, and a coexistence of two or more of the foregoing structures.

Examples of the metal elements or the metalloid elements capable of forming an alloy with lithium include magnesium, boron, arsenic (As), aluminum, gallium, indium, silicon, germanium, tin, lead (Pb), antimony (Sb), bismuth (Bi), cadmium (Cd), silver (Ag), zinc, hafnium (Hf), zirconium (Zr), yttrium (Y), palladium (Pd) and platinum (Pt). Examples of alloys or compounds thereof include alloys and compounds which are expressed by a chemical formula of DₛEₜLiᵤ. In this chemical formula, D represents at least one of metal elements and metalloid elements capable of forming an alloy with lithium. E represents at least one of elements other than lithium and D. Values of s, t and u are s>0, t≧0, and u≧0, respectively.

Specially, simple substances, alloys, or compounds of metal elements or metalloid elements in Group 14 in the long-period periodic table are preferable. Silicon or tin, or alloys or compounds thereof are more preferable. Silicon, or alloys or compounds thereof are particularly preferable. These materials can be crystalline or amorphous materials.

Concrete examples of such alloys or compounds include SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w=≦2), SnSiO₃, LiSiO, and LiSnO.

In this secondary battery, the cathode 21 also has an exposed region 21C wherein the active material layer 21B is not provided, an external active material region 21D wherein the active material layer 21B is provided only on the external side of the current collector 21A, and a both sides active material region 21E wherein the active material layers 21B are provided on both sides of the current collector 21A. The anode 22 also has an exposed region 22C wherein the active material layer 22B is not provided, an external active material region 22D wherein the active material layer 22B is provided only on the external side of the current collector 22A, and a both sides active material region 22E wherein the active material layers 22B are provided on both sides of the current collector 22A. Regarding the exposed region 21C of the cathode 21, two or more circuits are provided at the center side of the winding body, and one or more circuits are provided at the peripheral side of the winding body. Regarding the exposed region 22C of the anode 22, one or more circuits are provided at the center side of the winding body and at the peripheral side of the winding body, respectively. These exposed regions are intended to improve heat release characteristics, and promote heat diffusion and improve safety by selectively generating short circuit at the center side of the winding body and the peripheral side of the winding body of the battery when pressurized from outside the battery. In particular, when the anode 22 exists inside the cathode 21, it is possible that a welding trace of the cathode lead 25 penetrates the separator 23 to generate short circuit. Therefore, regarding the exposed region 21C at the center side of the winding body, one or more circuits are additionally provided compared to the exposed region 22C. Regarding the external active material region 21D, nearly one circuit is provided at the center side of the winding body. The external active material region 22D is provided at the center side of the winding body.

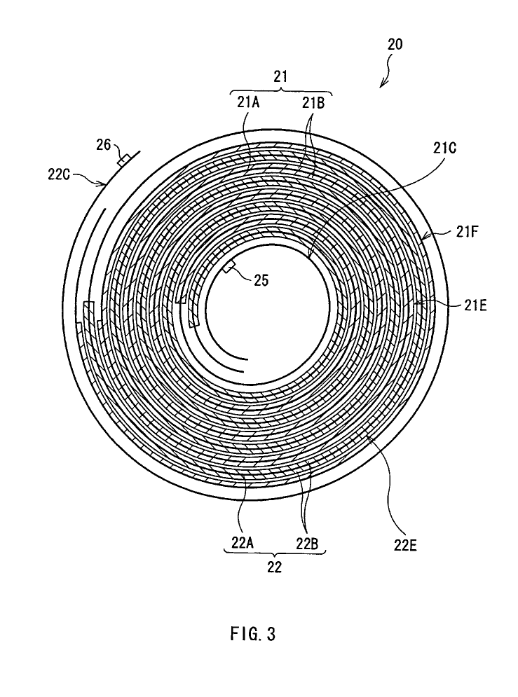

As shown in FIG. 3, regarding the cathode 21, the exposed region 21C can be two circuits or less if one or more circuits of the exposed region 21C are provided at the center side of the winding body. Regarding the anode 22, it is not necessary that one or more circuits of the exposed region 22C are provided at the center side of the winding body. Further, it is possible that the cathode 21 has an internal active material region 21F wherein the active material layer 21B is provided only at the internal side of the current collector 21A at the peripheral side of the winding body, and the internal active material region 21F is arranged to face the exposed region 22C of the anode 22 provided at the peripheral side of the winding body. In this case, it is also possible to sufficiently improve the heat release characteristics and secure safety. In FIG. 3, the separator 23 is omitted.

The separator 23 is constructed of, for example, a porous film made of a polyolefin material such as polypropylene and polyethylene, or a porous film made of an inorganic material such as a ceramics nonwoven cloth. The separator 23 can have a structure in which two or more of the foregoing porous films are layered.

The electrolyte according to this embodiment is impregnated in the separator 23.

This secondary battery can be manufactured, for example, as follows.

First, for example, a cathode material capable of inserting and extracting lithium, a conductive agent, and a binder are mixed to prepare a cathode mixture. This cathode mixture is dispersed in a solvent such as N-methyl-2-pyrrolidone to obtain a cathode mixture slurry. Next, the current collector 21A is coated with this cathode mixture slurry, dried, and compression-molded to form the active material layer 21B. In the result, the cathode 21 is fabricated.

Further, for example, an anode material capable of inserting and extracting lithium and a binder are mixed to prepare an anode mixture. This anode mixture is dispersed in a solvent such as N-methyl-2-pyrrolidone to obtain an anode mixture slurry. Next, the current collector 22A is coated with this anode mixture slurry, dried, and compression-molded to form the active material layer 22B. In the result, the anode 22 is fabricated.

Subsequently, the cathode lead 25 is attached to the current collector 21A by welding and the like, and the anode lead 26 is attached to the current collector 22A by welding and the like. After that, the cathode 21 and the anode 22 are layered and wound with the separator 23 in between. An end of the cathode lead 25 is welded to the safety valve mechanism 15, and an end of the anode lead 26 is welded to the battery can 11. The wound cathode 21 and anode 22 are sandwiched between the pair of insulating plates 12 and 13, and the cathode 21 and the anode 22 are housed inside the battery can 11. After the cathode 21 and the anode 22 are housed inside the battery can 11, the electrolytic solution is injected inside the battery can 11, and impregnated in the separator 23. After that, at the open end of the battery can 11, the battery cover 14, the safety valve mechanism 15, and the PCT device 16 are fixed by caulking through the gasket 17. The secondary battery shown in FIG. 1 is thereby completed.

In this secondary battery, when charged, for example, lithium ions are extracted from the cathode 21, and are inserted in the anode 22 through the electrolyte. When discharged, for example, lithium ions are extracted from the anode 22, and are inserted in the cathode 21 through the electrolyte. Further, when this secondary battery is left under the circumstances of high temperatures, part of the electrolyte salt is decomposed, and free acid is generated. Self-discharge is thereby caused, and a capacity is lowered. However, in this embodiment, the electrolyte contains the foregoing additive. Therefore, the free acid is captured by unpaired electrons of nitrogen contained in the compound, and the self-discharge at high temperatures is inhibited.

As described above, in the electrolyte of this embodiment, at least one from the group consisting of the compound having the structure shown in Chemical formula 1, the compound having the structure shown in Chemical formula 2, and the ionic liquid having the structure shown in Chemical formula 3 is contained. Therefore, the free acid can be effectively captured by the unpaired electrons of nitrogen contained in the compound. In the result, according to the secondary battery of this embodiment, even when the free acid causing the self-discharge is generated under the circumstances of high temperatures, the free acid can be captured by the electrolyte. Consequently, a self-discharge ratio at high temperatures can be lowered, and lowering of a capacity due to the self-discharge can be inhibited even when the secondary battery is left under the circumstances of high temperatures.

### EXAMPLES

Further, descriptions will be given in detail of concrete examples of the invention.

### Examples 1 to 9

Secondary batteries explained in the embodiment were fabricated. A structure of the electrode winding body 20 was as shown in FIG. 3. As an electrolyte, a mixture of a mixed solvent wherein a volume ratio between ethylene carbonate and dimethyl carbonate is 2:8; an additive, any of the compounds shown in Chemical formulas 5 to 9, Chemical formulas 11 to 13, and Chemical formula 15; and an electrolyte salt, LiPF₆ was used. An amount of the additive was changed in the range from 0.01 to 1.0 mol/l as shown in Table 1 and Table 2. An amount of the electrolyte salt was 1 mol/l, which was a concentration to a solvent. As a cathode material, an active material, LiCoO₂; the carbon black (name of article: Ketjen black) as a conductive agent; and polyvinylidene fluoride as a binder were used so that a mass ratio thereof became 93:3:4. Further, as an anode material, a carbon material of graphite being 15 μm in an average particle diameter as an active material and polyvinylidene fluoride as a binder were used so that a mass ratio thereof became 94:6.

TABLE 1

| | | | Cycle | Self- |
|---|---|---|---|---|
| | | | capacity | discharge |
| | | Amount of | retention | ratio at high |
| | | additive | ratio | temperatures |
| | Additive | (mol/l) | (%) | (%) |
| Example 1-1 | Chemical formula 5 | 0.01 | 80 | 4.4 |
| Example 1-2 | | 0.1 | 81 | 4.5 |
| Example 1-3 | | 0.5 | 80 | 4.4 |
| Example 1-4 | | 1 | 72 | 4.4 |
| Example 2-1 | Chemical formula 6 | 0.01 | 79 | 4.3 |
| Example 2-2 | | 0.1 | 80 | 4.4 |
| Example 2-3 | | 0.5 | 80 | 4.4 |
| Example 2-4 | | 1 | 71 | 4.3 |
| Example 3-1 | Chemical formula 7 | 0.01 | 80 | 4.5 |
| Example 3-2 | | 0.1 | 80 | 4.6 |
| Example 3-3 | | 0.5 | 79 | 4.6 |
| Example 3-4 | | 1 | 73 | 4.5 |
| Example 4-1 | Chemical formula 8 | 0.01 | 79 | 4.4 |
| Example 4-2 | | 0.1 | 79 | 4.5 |
| Example 4-3 | | 0.5 | 80 | 4.4 |
| Example 4-4 | | 1 | 72 | 4.4 |
| Example 5-1 | Chemical formula 9 | 0.01 | 80 | 4.4 |
| Example 5-2 | | 0.1 | 80 | 4.5 |
| Example 5-3 | | 0.5 | 79 | 4.4 |
| Example 5-4 | | 1 | 71 | 4.3 |
| Comparative | Not used | 0 | 79 | 10 |
| example | | | | |

TABLE 2

| | | | Cycle | Self- |
|---|---|---|---|---|
| | | Amount | capacity | discharge |
| | | of | retention | ratio at high |
| | | additive | ratio | temperatures |
| | Additive | (mol/l) | (%) | (%) |
| Example 6-1 | Chemical formula 11 | 0.01 | 79 | 4.5 |
| Example 6-2 | | 0.1 | 79 | 4.5 |
| Example 6-3 | | 0.5 | 79 | 4.4 |
| Example 6-4 | | 1 | 72 | 4.4 |
| Example 7-1 | Chemical formula 12 | 0.01 | 80 | 4.5 |
| Example 7-2 | | 0.1 | 81 | 4.5 |
| Example 7-3 | | 0.5 | 79 | 4.6 |
| Example 7-4 | | 1 | 73 | 4.5 |
| Example 8-1 | Chemical formula 13 | 0.01 | 79 | 4.3 |
| Example 8-2 | | 0.1 | 81 | 4.4 |
| Example 8-3 | | 0.5 | 79 | 4.3 |
| Example 8-4 | | 1 | 72 | 4.3 |
| Example 9-1 | Chemical formula 15 | 0.01 | 79 | 4.3 |
| Example 9-2 | | 0.1 | 80 | 4.4 |
| Example 9-3 | | 0.5 | 79 | 4.4 |
| Example 9-4 | | 1 | 71 | 4.4 |
| Comparative | Not used | 0 | 79 | 10 |
| example | | | | |

Regarding the fabricated secondary batteries of Examples 1 to 9, their cycle characteristics and self-discharge ratios after being left under the circumstances of high temperatures were examined.

Cycle characteristics were examined by obtaining a capacity retention ratio as a ratio of a discharge capacity at the 300th cycle to a discharge capacity obtained in the first charge and discharge (hereinafter referred to as initial capacity). Regarding the charge and discharge, charge was conducted for two hours at a constant current of 1 C by setting a battery voltage to 4.2 V at 23° C., and then discharge was conducted at a constant current of 1 C until a battery voltage reached 2.5 V. 1 C means a current value with which the initial capacity was discharged in one hour. Obtained results are shown in Table 1 and Table 2.

The self-discharge ratios after the secondary batteries were left under the circumstances of high temperatures were obtained as follows. First, after charge was conducted at 23° C., the secondary batteries were left for 30 days at 60° C. After that, a temperatures was returned to 23° C., discharge was conducted to obtain a capacity. Calculation was made by multiplying the value obtained by subtracting a ratio of a capacity after being left under the circumstances of high temperatures to the initial capacity from 1 by 100, that is, by [1−(a capacity after being left under the circumstances of high temperatures/initial capacity)]×100. The charge and discharge were conducted under the same conditions as when cycle characteristics were obtained. Obtained results are shown in Table 1 and Table 2.

As evidenced by Table 1 and Table 2, according to Examples 1 to 9 in which the additives were added, self-discharge ratios at high temperatures could be lowered compared to Comparative example in which no additive was added. It is thinkable that the reason thereof was that free acid could be captured by unpaired electrons of nitrogen contained in the compound. Further, when the additives were added, cycle characteristics were not lowered. Therefore, it was found that it was effective to inhibit self-discharge under the circumstances of high temperatures if at least one from the group consisting of the compound having the structure shown in Chemical formula 1, the compound having the structure shown in Chemical formula 2, and the ionic liquid having the structure shown in Chemical formula 3 was contained.

While the invention has been described with reference to the embodiment and Examples, the invention is not limited to the foregoing embodiment and Examples, and various modifications may be made. For example, in the foregoing embodiment and Examples, the structures of the electrode winding body 20 have been explained by using concrete examples. However, the invention can be applied to cases using other winding structures. Further, the invention can be applied to a secondary battery having a winding structure in the shape of an oval or a polygon, and a secondary battery having a structure wherein a cathode and an anode are folded or layered as well. Further, the invention can be applied to a secondary battery in the shape of a coin, a button, or a card. Furthermore, the invention can be applied not only to the secondary batteries, but also to primary batteries.

Further, in the foregoing embodiment and Examples, the case using lithium complex oxide as a cathode active material has been described. However, a chalcogen compound containing an alkali metal other than lithium and a transition metal, in particular, an oxide containing an alkali metal other than lithium and a transition metal can be used. As a crystal structure of these compounds, for example, a layer compound and a spinel type compound can be cited. As a layer compound, for example, a compound expressed by a chemical formula of A_{q}M3₁₋ᵣM4ᵣO₂ can be cited. In the formula, A represents sodium or potassium, M3 represents at least one from the group consisting of iron, cobalt, nickel, manganese, copper, zinc, chromium, vanadium, and titanium. M4 represents at least one from the group consisting of iron, cobalt, manganese, copper, zinc, aluminum, tin, boron, gallium, chromium, vanadium, titanium, magnesium, calcium, and strontium. Values of q and r are 0.5≦q≦1.1 and 0<r<1, respectively.

Obviously many modifications and variations of the present invention are possible in the light of the above teachings. It is therefore to be understood that within the scope of the appended claims the invention may be practiced otherwise than as specifically described.

1. An electrolyte, containing at least one from the group consisting of a compound having a structure shown in Chemical formula 1, a compound having a structure shown in Chemical formula 2, and an ionic liquid having a structure shown in Chemical formula 3. 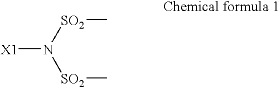
(In the formula, X1 represents any of a hydrogen group, a halogen group, and a group containing carbon.) 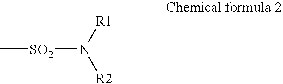
(In the formula, R1 and R2 represent a group containing carbon, and R1 and R2 are bonded by nitrogen and carbon.)

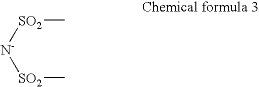

2. An electrolyte according to claim 1, containing at least one from the group consisting of compounds shown in Chemical formulas 4 to 12.

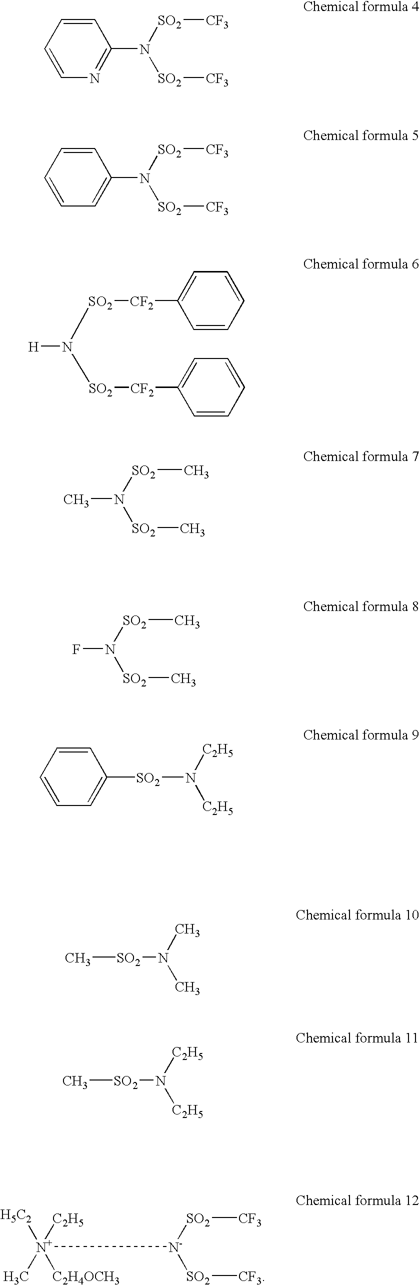

3. A battery, comprising:
a cathode;
an anode; and
an electrolyte,
wherein the electrolyte contains at least one from the group consisting of a compound having a structure shown in Chemical formula 1, a compound having a structure shown in Chemical formula 2, and an ionic liquid having a structure shown in Chemical formula 3.

4. A battery according to claim 3, containing at least one from the group consisting of compounds shown in Chemical formulas 4 to 12.

5. A battery according to claim 3, wherein the cathode comprises:
a current collector having a pair of facing faces; and
an active material layer containing lithium complex oxide provided on the current collector.

6. A battery according to claim 5, wherein the lithium complex oxide is LiCoO₂.

7. A battery according to claim 3, wherein the anode comprises:
a current collector having a pair of facing faces; and
an active material layer containing a carbon material provided on the current collector.

8. A battery according to claim 7, wherein the carbon material is graphite.

9. A battery according to claim 3, wherein the electrolyte further contains a solvent and an electrolyte salt dissolved in the solvent.

10. A battery according to claim 9, wherein concentrations of the compound having the structure shown in Chemical formula 1, the compound having the structure shown in Chemical formula 2, and the ionic liquid having the structure shown in Chemical formula 3 are from 0.01 mol/l to 0.5 mol/l to the solvent.
